(19) United States
(12) Patent Application Publication
(10) Pub. No.: US 2021/0048806 A1
(43) Pub. Date: Feb. 18, 2021

(54) SYSTEM AND METHODS FOR GRAY-BOX ADVERSARIAL TESTING FOR CONTROL SYSTEMS WITH MACHINE LEARNING COMPONENTS

(71) Applicants: Georgios Fainekos, Tempe, AZ (US); Shakiba Yaghoubi, Tempe, AZ (US)

(72) Inventors: Georgios Fainekos, Tempe, AZ (US); Shakiba Yaghoubi, Tempe, AZ (US)

(73) Assignee: Arizona Board of Regents on behalf of Arizona State University, Tempe, AZ (US)

(21) Appl. No.: 16/994,967

(22) Filed: Aug. 17, 2020

Related U.S. Application Data
(60) Provisional application No. 62/887,988, filed on Aug. 16, 2019.
(60) Provisional application No. 62/888,788, filed on Aug. 19, 2019.

(51) Int. Cl. G05B 19/418; G06N 3/08; G06N 20/00

(52) U.S. Cl. CPC G05B 19/41885; G06N 20/00; G06N 3/08

(57) ABSTRACT

Embodiments of systems and methods for gray-box adversarial testing for control systems with machine learning components are disclosed.

### CROSS REFERENCE TO RELATED APPLICATIONS

This document is a U.S. non-provisional patent application that claims benefit to U.S. provisional patent application Ser. No. 62/887,988 filed on Aug. 16, 2019; and further claims benefit to U.S. provisional patent application Ser. No. 62/888,788 filed on Aug. 19, 2019, all of which is herein incorporated by reference in its entirety.

### GOVERNMENT SUPPORT

This invention was made with government support under grant number 1319560 awarded by the National Science Foundation. The Government has certain rights to this invention.

### FIELD

The present disclosure generally relates to systems and methods for Gray-Box adversarial testing; and in particular relates to a Gray-Box adversarial testing for control systems that can include machine learning components.

### BACKGROUND

Neural Networks (NN) have been proposed in the past as an effective means for both modeling and control of systems with very complex dynamics. However, despite the extensive research, NN-based controllers have not been adopted by the industry for safety critical systems. The primary reason is that systems with learning based controllers are notoriously hard to test and verify. Even harder is the analysis of such systems against system-level specifications.

There is a long history of investigating the application of NN in high assurance systems. The advantages of including a NN in the control loop can be substantial. For example, a system may include components with complex dynamics that cannot be modeled by first principles and need to be learned. Most importantly, a high assurance system needs to be able to adapt in catastrophic situations. NNs provide such an adaptation mechanism with only limited assumptions on the structure of what is to be learned. Even though there has been substantial progress in the stability analysis and verification of such systems, the problem of system level verification of transient system behaviors still remains a major challenge. It is with these observations in mind, among others, that various aspects of the present disclosure were conceived and developed.

### BRIEF DESCRIPTION OF THE DRAWINGS

FIG. 1 shows a class of dynamical systems containing a Neural Network;

FIG. 2 shows a framework for implementing the falsification gradient based method;

FIG. 3 is a graphical representation of a local optimal search finding an input that falsifies a requirement of a non-linear system with a Feed Forward Neural Network controller;

FIG. 4 shows a Simulink model of a dynamical system including a Recurrent Neural Network;

FIG. 5 is a graphical representation of initial and final trajectories and inputs of the Simulink model, where the final input and trajectory are created using the proposed approach;

FIG. 6 is an example schematic diagram of a computing system that may implement various methodologies of the system and method for gray-box adversarial testing for control systems with machine learning components; and

FIG. 7 is a simplified block diagram illustrating an exemplary network/system embodiment for a computer-implemented method of gray-box adversarial testing for control systems with machine learning components.

Corresponding reference characters indicate corresponding elements among the view of the drawings. The headings used in the figures do not limit the scope of the claims.

### DETAILED DESCRIPTION

In this disclosure, a gradient based method for searching the input space of a closed-loop control system in order to find adversarial samples against some system-level requirements is disclosed. Experimental results disclosed herein show that combined with a randomized search the disclosed method outperforms previous optimization methods.

In this disclosure, the progress on the automatic generation of adversarial test cases (falsification) for nonlinear control systems with NN components in the loop is reported on. System properties that can be specified using different logics may be assumed and expressed in Signal Temporal Logic (STL) and a framework may be developed that searches for adversarial tests through functional gradient descent. In particular, using a local optimal control based search combined with a global optimizer is proposed since the resulting optimization problem is non-convex.

It should be noted that the proposed approach may require neither analytical information about the system model nor the NN architecture. However, the framework may benefit from information readily available by most model based development tools for control systems. Namely, it may use linearizations of the closed loop system at given operating points. The linearizations may help approximate the gradient descent directions without the need for computing sensitivity matrices or numerical approximations of the descent directions.

It may be assumed that the NNs in the system include differentiable activation functions. This is not a restrictive assumption since most of the common approaches for training NNs are based on gradients which require differentiability, so activation functions are usually approximated to become smooth if they are not already. For instance, Rectified Linear Unit (ReLU) is the rectifier function ƒ(x)=max(0, x) whose corner is smoothed out as \tilde{ƒ}(x)=In(1+e^{x}).

The approach may be used for systems that contain Recurrent Neural Networks (RNN) which cannot be handled by the existing testing and verification methods. In general the current approach can be used for testing general Nonlear control systems regardless of whether or not they include NNs in the loop. Finally, it should be noted that the proposed method could be extended to hybrid control systems with NNs under certain circumstances.

Summary of contributions: An adversarial test generation (falsification) framework has been developed for control systems with RNN in the loop based on optimal control theory. Unlike works in which the input signal is parameterized using finite number of parameters, in this work the input may be calculated using an optimal-control approach which searches directly in the infinite search space of the input functions. It is experimentally demonstrated that the framework vastly outperforms black-box system testing methods. Namely, in a case study described herein, the proposed framework consistently returns falsifications when the black-box methods fail to do so.

### Preliminaries

Neural Networks: Neural Networks are brain-inspired functions/dynamical systems that can learn to replicate real systems if provided by enough data about that system. NN's consist of input, output and usually hidden layers that each includes a number of nodes/neurons connected to transform the input into a suitable signal for replicating the desired output. The input layer passes the inputs to the network, where some computations are applied on them in the hidden layers, and the output layer consists of at least one node that generates the output vector. The inputs to each node are the outputs from other nodes, and the output of each node is computed by applying nonlinear functions to the weighted sum of its inputs. Many methods have been studied in literature to train a NN to replicate a system's behavior, most of which minimize a loss function, such as the mean-squared error of the output. Two types of the most generally used NNs are briefly introduced in the following:

Feed forward Neural Networks (FNN). FNNs are the simplest type of NNs. They are static or memory-less networks with no feedback loops. Multi-layer perceptron (MLP) is the most general form of FNN, which has the ability to approximate any nonlinear function. Assuming/layers in the FNN, the ith layer applies the following function to its inputs uᵢ∈ [symbol] ^{m}ᵢ,

yᵢ=øᵢ(Wᵢ^{T}uᵢ^{+b}ᵢ)i∈{1,2 . . . ,I} (1)

where assuming that the layer has nᵢ outputs yᵢ∈ [symbol] ⁿᵢ (usually nᵢ=mᵢ₊₁), Wᵢ is a [symbol] ^{m}ᵢ H [symbol] ⁿᵢ weight matrix, bᵢ∈ [symbol] ⁿᵢ is a bias vector, and øᵢ: [symbol] ^{m}ᵢ→ [symbol] ⁿᵢ an activation function which is usually one of the continuous nonlinear functions: ReLU, tan h, arctan, logistic or sigmoid. The weight matrices Wᵢ and the bias vectors bi should be adjusted using a training approach. After the training phase, the function FNN: [symbol] ^{m}ᵢ→ [symbol] ⁿᵢ formed by neurons of Eq. (1), calculates the final output of the feed forward neural net at time t given the input at that time: y(t)=FNN(u(t)).

Recurrent Neural Networks (RNN). Unlike FNNs, RNNs are dynamic networks. The feedback loops between neurons equip the network with long/short term memory. The output at each time t represented as y(t)=RNN(t, u(·)) is a function of the vectorized input signal/sequence u(·) and is a solution to the following continuous or discrete system of equations:

\dot{X}ₙₙ=ƒ_{c}^{T}(Xₙₙ,u), or

xₙₙ(t)=ƒ_{d}^{r}(xₙₙ(t−1),xₙₙ(t−2), . . . ,u(t))

y(t)−g(xₙₙ(t)) (2)

where xₙₙ is the internal state (memory) of the RNN which is usually initially zero (xₙₙ(0)=0). These states are the outputs of the delay/integrator blocks whose inputs are calculated using the functions ƒ_{c}^{r} or ƒ_{d}^{r} given the input and (previous) states. Note that despite FNN formulation in Eq. (1), the above formulation describes the overall input output relationship of the RNN rather than the individual neurons. The RNN output at each time t is a function of the states xₙₙ at t.

The solution of an arbitrary NN at time t is denoted as NN(t, u(·)).

### Closed-Loop Control Systems Description

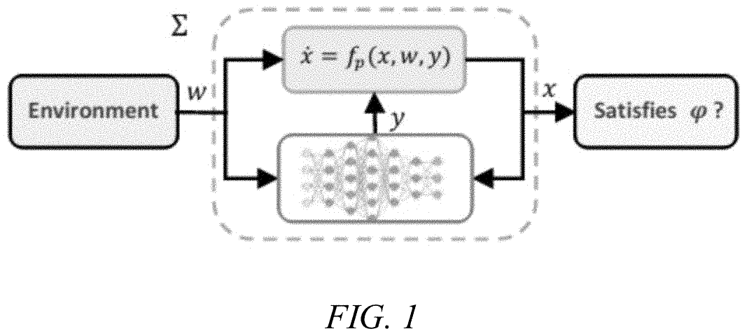

In this paper NNs can be combined with a system plant in a general way. Many of the dynamical systems in which NNs are used for controls (in feedback, feedforward or end-to-end), unmodeled dynamics estimation or predictions, can lie under the class of systems that we consider (shown in FIG. 1). The system is studied in the bounded time interval [0, T] and described in the following.

Σ: \dot{x}ₚₚ=ƒₚ(xₚ,w,NN(t,xₚ(·),w(·))) (3)

where xₚ∈X⊂ [symbol] ⁿ, xₚ(0)∈X₀, and w∈∪⊂ [symbol] ^{m} are the system states, state initial values, and inputs, respectively. Also, x(·), w(·) are the state and input trajectories, NN: [symbol] ₊H X^{[0, T]} H ∪^{[0, T]}→ [symbol] ^{k}, and ƒₚ: [symbol] ⁿ H [symbol] ^{m} H [symbol] ^{k}→ [symbol] ⁿ are C¹ functions. The solution to system (3) at time t with initial condition xₚ(0) and input w is denoted by sₚ(t, xₚ(0), w).

### Specifications

Desired system behaviors can be specified using Signal Temporal logic (STL) formulas. These formulas are created by combining atomic propositions or predicates using logical and temporal operators. Logical operators include: and (∧), or (∨), and not (¬), and temporal operators include: always (□), eventually (⋄), and until ( [symbol] ) that can be combined with time intervals to specify when operators are active.

Given the system state trajectory sₚ(t, x₀, w), a robustness value can be calculated with respect to an STL formula φ, which shows how well the trajectory satisfies the formula. Positive values indicate satisfaction and negative values indicate violation. The absolute value of the robustness shows how far the trajectory is from being satisfied/falsified.

The robustness value is calculated using max and min functions over the distances of the points on the trajectory from sets that are defined by the formula predicates and as a result the robustness function is not differentiable. Previous works approximately define differentiable semantics of logic. The accuracy of the approximation however depends on various parameters and there is not a mature enough tool to calculate the robustness using them yet either. So in the following, these limitations are considered when dealing with the non-differentiability of the robustness function.

It can be shown that the absolute value of the robustness of the trajectory sp(t, xₚ(0), w) corresponds to the distance between a point sₚ(t*, xₚ(0), w) on the trajectory and a point z* that belongs to a critical set. The critical set corresponds to a predicate in the STL formula φ, and t* is called the critical time. The variables z* and t* are simply calculated using tools such as S-Taliro while evaluating the robustness. The robustness of neighboring trajectories sₚ(t, xₚ′(0), w′) where xₚ′(0)=xₚ(0)+δxₚ(0), and w′(t)=w(t)+δw(t) is upper bounded by ∥sₚ(t*, xₚ′(0), w′)−z*∥ so minimizing the following cost with respect to xₚ′(0) and w′ will locally minimize the robustness function. Note that the dependence of the cost function on xₚ(0) and w is through z* and t*.

Jₓ_{ₚ}_{(0),w}=½(sₚ(t_{*}xₚ′(0),w′)−z_{*})^{T}(sₚ(t_{*},xₚ′(0),w′)−z_{*}) (4)

### Analytical Adversarial Testing

### Problem Formulation

In adversarial testing, a primary interest is in finding adversarial w∈∪^{[1, T]} and x₀∈X₀ for which the solution to the system (3) does not satisfy a given formula φ. The adversary can be used later to improve the system performance by adapting or retraining the NN. The problem may be looked at as a constrained optimization problem in which the robustness function is minimized over X₀ and ∪^{[0, T]} and under the dynamics of Eq. (3). This optimization problem can be locally solved by minimizing the cost in Eq. (4) instead of the robustness value. Also, the NN may be integrated with the plant and the system in Eq. (3) may be rewritten as:

\dot{x}=ƒ(x,w) (5)

The solution to system (5) at time t with initial condition x(0) and input w is denoted by s(t, x(0), w). Note that the states of the closed loop system above (x) include the states of the plant (xₚ∈ [symbol] ⁿ) and possible states of the neural network (xₙₙ, ∈ [symbol] ^{b}, b≤0). However the system requirements are usually on the plant states rather than the NN states, so the value of the neural net states xₙₙ do not affect the robustness value directly. As a result z*∈ [symbol] ⁿ only concerns xp and any value of xₚ is considered to be desired for falsification. In this disclosure, the superscript i shows the variables corresponding to the i-th iteration.

Problem 1. At the ith iteration, given an STL formula φ, an initial condition xₚⁱ,(0), and an input signal wⁱ, find the solution to the system of Eq. (5): s(t, xⁱ(0), wⁱ) [symbol] xⁱ=[xₚⁱ, xₙₙⁱ], where xⁱ(0)=[xₚⁱ(0), zeros(b)]. Calculate for the formula φ, the critical time t_{*}ⁱ and the critical point z_{*}ⁱ corresponding to xₚⁱ. Let r_{*}ⁱ [symbol] [z_{*}ⁱxₙₙⁱ(t_{*}ⁱ)], and solve the following constrained minimization problem:

$${Minimize}_{{x}_{p} ( 0 ) , w} {J}^{i} = \frac{1}{2} {( x ( {t}_{*}^{i} ) - {r}_{*}^{i} )}^{⊤} ( x ( {t}_{*}^{i} ) - {r}_{*}^{i} ) \\ s . t \dot{x} = f ( x , w ) \\ {x}_{p} ( 0 ) ∈ {X}_{0} , w ∈ U \qquad ( 6 )$$

### Specification Falsification Attack

Due to the nonlinear constraints, finding the global minimizer to Problem (1) may not be guaranteed. However, taking a small enough step in the direction of the negative of the gradient of the cost function (6) with respect to xo and w, will decrease the cost locally. Using the method of the Lagrange multipliers, Problem 1 can be reduced to the problem of minimizing the following cost function:

$${J}^{i} = \frac{1}{2} {( x ( {t}_{*}^{i} ) - {r}_{*}^{i} )}^{⊤} ( x ( {t}_{*}^{i} ) - {r}_{*}^{i} ) + {\int }_{0}^{{t}_{*}^{i}} {λ}^{⊤} ( f ( x , w ) - \frac{dx}{dt} ) dt$$

Forming the Hamiltonian as H(x, w)=λ^{T} ƒ(x, v ji and øⁱ(x)=½(x−r_{*}ⁱ)^{T} (x−r_{*}ⁱ), can be written as:

$${J}^{i} = {φ}^{i} ( x ( {t}_{*}^{i} ) ) + {λ ( 0 )}^{⊤} x ( 0 ) - {λ ( {t}_{*}^{i} )}^{⊤} x ( {t}_{*}^{i} ) + {\int }_{0}^{{t}_{*}^{i}} ( H ( x , w ) + \frac{d λ}{dt} ⊤ x ) dt$$

As a result, th J^{l} gradient of the cost function is:

$$δ {J}^{i} = ( \frac{d {φ}_{i} ( {x}^{i} ( {t}_{*}^{i} ) )}{dx} - {λ}^{⊤} ( {t}_{*}^{i} ) ) δ x ( {t}_{*}^{i} ) + {λ}^{⊤} ( 0 ) δ x ( 0 ) + {\int }_{0}^{{t}_{*}^{i}} ( ( \frac{\partial H}{\partial x} + {λ}^{⊤} ) δ x + \frac{\partial H}{\partial w} δ w ) dt$$

By updating the co-states λ backward in time with the following final value ordinary differential equation,

$$\begin{matrix}\dot{λ} = - \frac{\partial H}{\partial x} ⊤ = - \frac{\partial f}{\partial x} {\vert}_{{x}^{i} , {w}^{i}}^{⊤} λ & ( 7 ) \\ λ ( {t}_{*}^{i} ) = {( \frac{d {φ}^{i} ( {x}^{i} ( {t}_{*}^{i} ) )}{dx} )}^{⊤} = {x}^{i} ( {t}_{*}^{i} ) - {r}_{*}^{i} & ( 8 )\end{matrix}$$

δ J^{l} is reduced to δ

$${J}^{i} = {λ}^{⊤} ( 0 ) δ x ( 0 ) + {\int }_{0}^{{t}_{*}^{i}} \frac{\partial H}{\partial w} δ w dt .$$

The following choices of δx(0) and δw with a small enough positive step size h will result in a negative δ J^{l} and as a result a decrease in J^{l}:

$$\begin{matrix}δ {x}^{i} ( 0 ) = - λ ( 0 ) & ( 9 ) \\ δ {w}^{i} ( t ) = - \frac{\partial H}{\partial w} = - \frac{\partial f}{\partial w} {\vert}_{{x}^{i} , {w}^{i}}^{⊤} λ ( t ) & ( 10 )\end{matrix}$$

In order to find δx(0) and δw(t) using Eq. (7-10), either ƒ may be differentiated with respect to x and w, which requires knowledge about ƒ (or ƒₚ and NN) or we a modified version of a successive linearization approach may be used. Recall that linear approximations of ƒ around operating points can usually be provided. Given xₚⁱ (0) and wⁱ(t) assume N time samples are taken on the corresponding trajectory and the following is a linear approximation of Eq. (5) at sample time tₖ∈[0, T] (t₁=0, t_{N}=T)

\dot{x}=Aₖⁱx+Bₖⁱw k=1, . . . N

where Aₖⁱ, Bₖⁱ are constant matrices. For each time t∈[tₖ, tₖ₊₁], the time-varying functions Aⁱ(t) and Bⁱ(t) may be calculated as follows:

$${α}_{k} = \frac{{t}_{+ 1} - t}{{t}_{k + 1} - {t}_{k}} , {α}_{k + 1} = \frac{t - {t}_{k}}{{t}_{k + 1} - {t}_{k}} \\ {A}^{i} ( t ) = {α}_{k} {A}_{k}^{i} + {α}_{k + 1} {A}_{k + 1}^{i} , {B}^{i} ( t ) = {α}_{k} {B}_{k}^{i} + {α}_{k + 1} {B}_{k + 1}^{k} \qquad ( 11 )$$

δx(0) and δw(t) may be calculated using the following equations

A(t_{*}ⁱ)=xⁱ(t_{*}ⁱ)−r_{*}ⁱ (12)

λ=A(t)^{T}λ (13)

δxⁱ(0)=λ(0) (14)

δwⁱ(t)=−B(t)^{T}λ(t) (15)

The linearization matrices Aₖⁱ, Bₖⁱ can be computed analytically or approximated numerically. This approach can be applied to blackbox systems too. The MATLAB ‘Linearize’ command that may be used in the implementation can compute the linearizations analytically (using a block-by-block approach) or numerically (using perturbations) for Simulink models. However, Mathworks strongly recommends that the analytical approach is used as it is faster and more accurate.

Algorithm 1 describes the process of finding adversarial inputs and initial conditions. In this algorithm, InBox is a function that saturates its first input argument to lie in the set which is specified in its second input argument. Note that the algorithm can be stopped based on different criteria. For example, the algorithm can be stopped if:
A maximum number of iterations is reached.
The change in the robustness is less than a minimum value.
The changes in the initial conditions and inputs are less than a minimum value.

Algorithm 1 operates as follows”

Algorithm 1 Optimal input and initial condition for falsification
Require: TL formula φ, xₚ¹(0), w¹(t), X₀, U, and a tool to extract linearizations of ƒ, and initial step size h₀, and constant c>1.
Ensure: local optimal initial condition xₚ*, local optimal input w*.
1: Initialize i=1, d*=∞, h=h₀
2: Evaluate the system response xⁱ(t), and find the corresponding robustness value d, and t_{*}ⁱ, r_{*}ⁱ.
3: If d<d* let d*=d, xₚ*(0)=xₚⁱ(0), w*=wⁱ, and h=ch, otherwise let h=h/c and go to step 6.
4: If d<0 (φ is falsified): stop and return the corresponding xₚ*(0), w*.
5: Linearize the system around sample times taken in [0, t_{*}ⁱ] and evaluate δxⁱ(0) and δwⁱ using equations (11-15).
6: While the stop condition is not active, let xₚⁱ(0)=InBox(xₚⁱ(0)+h δₚⁱ(0), X₀) ¹and ∀t∈[0, t_{*}ⁱ]: wⁱ(t)=InBox(wⁱ(t)+h δwⁱ(t), U) and go back to step 2. (δxₚⁱ(0) is the non NN part of δxⁱ(0))
7: Let i=i+1, δxⁱ(0)=δxⁱ⁻¹(0) and δwⁱ=δwⁱ⁻¹.

### Framework

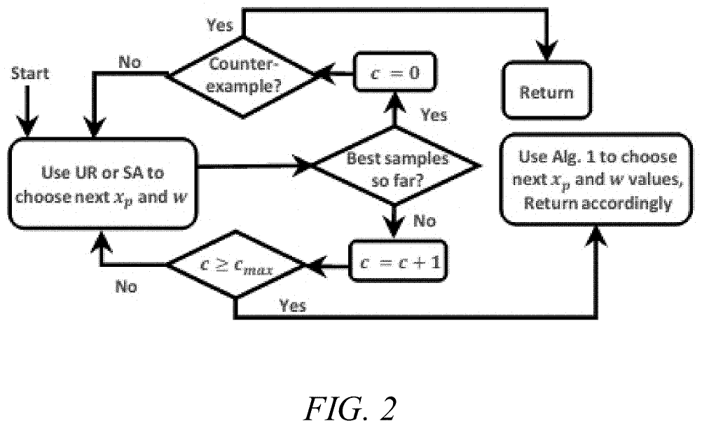

The robustness function is a non-convex non-differentiable function in nature. In order to locally solve the problem the function has been defined. However, in order to search for the global minimizer of the robustness function, the gradient based local search may still need to be combined with a “sampling method for coverage” or a “stochastic global optimization” approach. In what follows the local search is combined with Uniform Random Sampling (UR) and Simulated Annealing optimization (SA). The framework is shown in FIG. 2, where c=0 in the beginning and cₘₐₓ is a design choice.

### Case Studies

In this section two systems containing NNs are studied. The NNs serve as controllers and they are trained to replicate the behavior of well-known controllers. Motivated by the fact that Simulink models are widely used in industry for modeling complicated systems, both of the studies are Simulink models that are treated as gray-box, and the information that extracted from the models is the dynamical model linearizations along systems' trajectories that are anyway extractable using the Simulink's linear analysis toolbox. Note that the proposed approach is applicable to general model based design frameworks and is not limited to Simulink models.

Nonlinear System with FNN Controller

Consider the following nonlinear system under a FNN controller that has 5 layers and tangent-sigmoid activation functions. Also let

x₁(0)=−0.2,x₂(0)=5, and w(t)∈[−0.1,0.1]:

\dot{x}₁=−0.5x₁−2e^{-0.5t} sin(3t)+sin(x₂)

\dot{x}₂=−x₂+x₁²(cos(x₂+w(t))+FNN(x₁,x₂)

The system is tested against the specification:

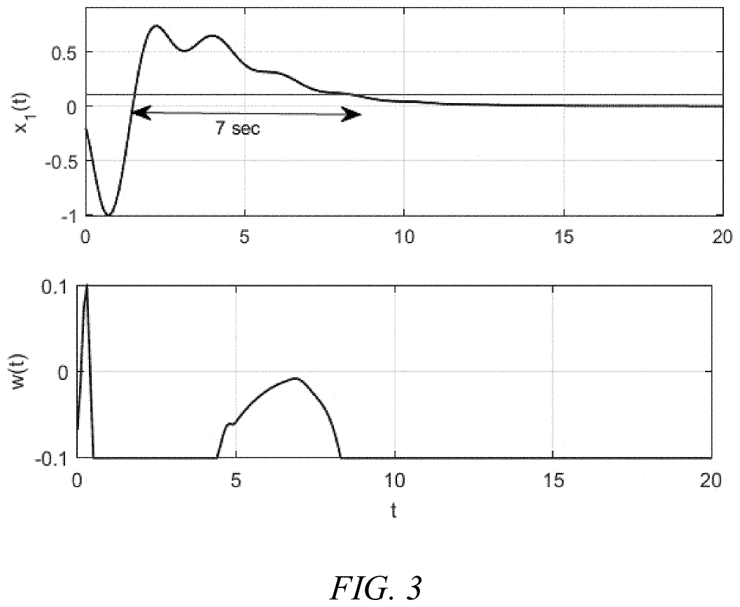

□((x₁(t)<0∧⋄_{[0,∈]}x₁(t)>⋄_{[0,7]}□(x₁(t)<0.1))

in which ∈ is a small positive constant. The requirement requires the signal to always stay below 0.1 within 7 second of the rise time. Starting from w(t)=0 the local optimal search finds an input (shown in FIG. 3) that falsifies the requirement. The robustness for the falsifying trajectory is −7.7 H 10⁻⁷.

Steam Condenser with RNN Controller

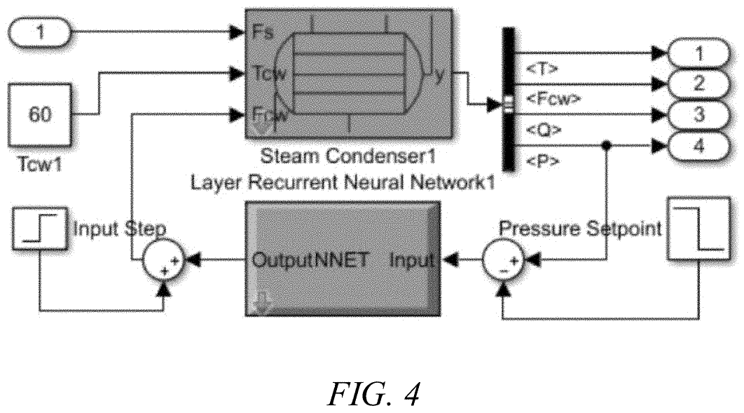

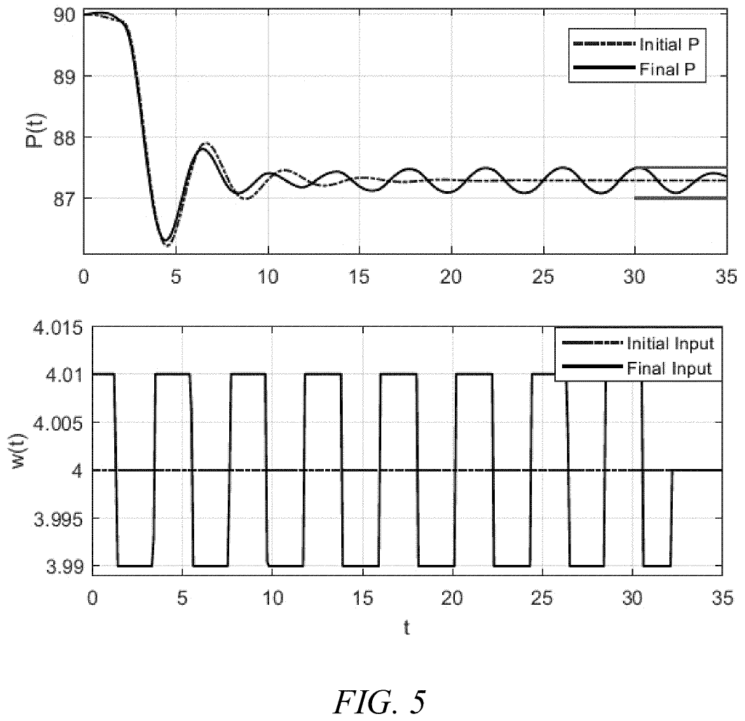

A dynamic model of a steam condenser with 5 continuous states based on energy balance and cooling water mass balance under an RNN controller with 6 discrete states and tangent-sigmoid activation functions is studied. The Simulink model for the system is shown in FIG. 4. The steam flow rate w(t) (Input 1 in FIG. 4) is allowed to vary in the set [3.99, 4.01] and the system is tested for T=35 seconds against the specification □_{[30,35]} p(t)∈[87, 87.5]. Starting from a constant valued signal w(t)=4 that results in a robustness value equal to 0.20633, the above approach finds a falsifying trajectory with robustness 0.00030222. The initial and final trajectories and inputs are shown in FIG. 5. Using w(t)=3.99 and w(t)=4.01 initially, the robustness values were reduced from 0.24131 to 0.00033674 and from 0.17133 to 0.0002290, respectively. These nearly falsifying trajectories are the result of very similar inputs with small differences in switch times. These small differences result in slightly different robustness values due to the hard timing constraints in the requirement. While the local search reduces the robustness values significantly in all the above 3 cases, in none of them a falsifying behavior is found. The importance of combining this local search with a global sampler/optimizer becomes clearer in the next section where the combination of the local search with uniform random sampling or Simulated Annealing method finds adversarial examples.

Note that, while the utilized NNs have a fairly small number of layers (since they were found to perform good enough during the training phase), the scalability of the proposed approach was tested on the systems of Sec. 5.1 and 5.2 including NN controllers with larger number of layers (20 to 100) too. These experiments showed that the proposed approach scales well. Theoretically increasing the number of layers/neurons in FNNs or the number of non-recurrent layers (with no delay/memory) in RNNs will just increase the number of blocks in the Simulink model linearly. Since MATLAB analytical linearization is computed block-by-block, increasing the number of these kinds of layers (l) increases the linearization complexity by O(l·r) where r is the maximum number of neurons in layers. However increasing the size of state-space or the number of layers of the RNN with memory increases the linearization complexity faster. Specifically the size of linearized matrices grows quadratically with the number of state-space plus RNN states. However, in practice, much less increase is observed in the computation time of the overall algorithm when increasing the size of the NN states.

### Experimental Results

Experiments are conducted using MATLAB 2017a on an Intel® Core™ i7-4790 CPU @3.6 GHZ with 16 GB memory processor with Windows 10 Enterprise.

TABLE 1
Falsification Results of Steam Condenser system with
RNN controller using different search methods.

| | UR | SA | UR + GD | SA + GD |
|---|---|---|---|---|
| # falsifications | 0/50 | 0/50 | 50/50 | 50/50 |
| Avg. min robustness | 0.0843 | 0.0503 | −0.0018 | −0.0016 |
| Avg. execution time | >60 | >60 | 15.7812 | 13.0688 |
| Avg. # simulations | 600 | 600 | 87.48 | 62.26 |

Uniform the Random Sampling (UR) and Simulated Annealing (SA) implementations of S-Taliro are used unaided and aided by the optimal local search (UR+GD and SA+GD, respectively) for finding adversarial inputs to the more difficult problem described in Sec. 5.2 with RNN in the loop. For sampling using SA and UR, inputs were (initially) considered to be piece-wise constant signals with 12 control points with varying sample times (total of 24 variables). In the UR+GD implementation, local optimal search is performed when the sampler cannot find a sample with a less robustness value 50 times in a row, and in the SA+GD implementation it is applied when the optimizer cannot find a less robust sample 30 times in a row. The experiments are run 50 times, and in each run the maximum execution time is limited to 60 seconds. The search is initialized with the same seed for all the experiments. The above search methods are compared against the number of falsifications found, average minimum robustness found, average execution time, and average total number of simulations before returning. The improvement in the results from left to right in Table 1 is evident and it motivates the use of the proposed local search. While SA and UR were not able to find any counterexamples in 50 runs, their combination with gradient based descent found an adversarial example in all the runs within a short amount of time and with less than 90 simulations on average.

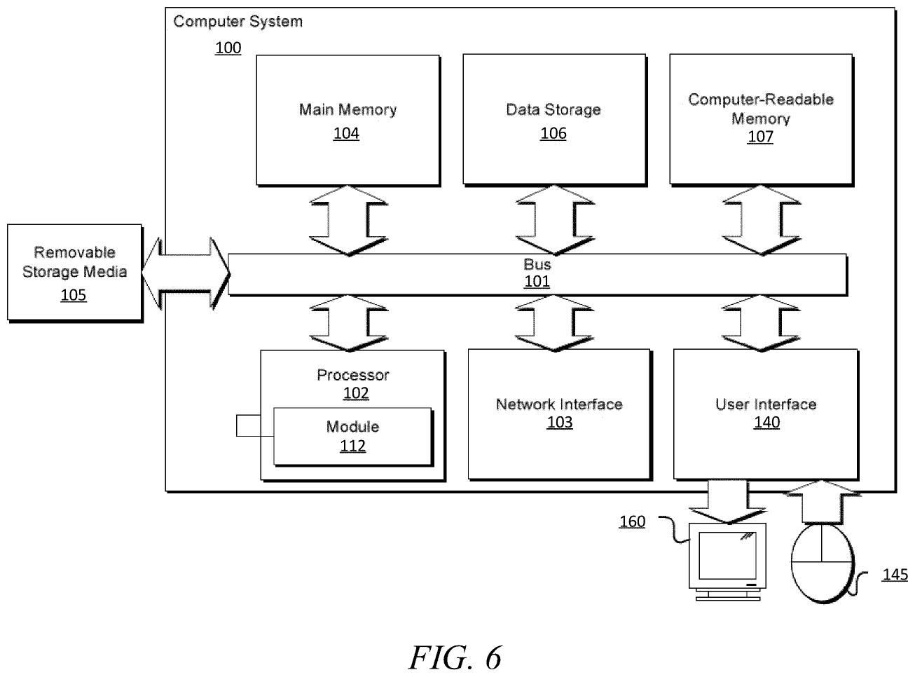

FIG. 6 illustrates an example of a suitable computing system 100 used to implement various aspects of the present system and methods with gray-box adversarial testing for control systems with machine learning components. Example embodiments described herein may be implemented at least in part in electronic circuitry; in computer hardware executing firmware and/or software instructions; and/or in combinations thereof. Example embodiments also may be implemented using a computer program product (e.g., a computer program tangibly or non-transitorily embodied in a machine-readable medium and including instructions for execution by, or to control the operation of, a data processing apparatus, such as, for example, one or more programmable processors or computers). A computer program may be written in any form of programming language, including compiled or interpreted languages, and may be deployed in any form, including as a stand-alone program or as a subroutine or other unit suitable for use in a computing environment. Also, a computer program can be deployed to be executed on one computer, or to be executed on multiple computers at one site or distributed across multiple sites and interconnected by a communication network.

Certain embodiments are described herein as including one or more modules 112. Such modules 112 are hardware-implemented, and thus include at least one tangible unit capable of performing certain operations and may be configured or arranged in a certain manner. For example, a hardware-implemented module 112 may comprise dedicated circuitry that is permanently configured (e.g., as a special-purpose processor, such as a field-programmable gate array (FPGA) or an application-specific integrated circuit (ASIC)) to perform certain operations. A hardware-implemented module 112 may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module 112 that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules 112 are temporarily configured (e.g., programmed), each of the hardware-implemented modules 112 need not be configured or instantiated at any one instance in time. For example, where the hardware-implemented modules 112 comprise a general-purpose processor configured using software, the general-purpose processor may be configured as respective different hardware-implemented modules 112 at different times. Software may accordingly configure a processor 102, for example, to constitute a particular hardware-implemented module at one instance of time and to constitute a different hardware-implemented module 112 at a different instance of time.

Hardware-implemented modules 112 may provide information to, and/or receive information from, other hardware-implemented modules 112. Accordingly, the described hardware-implemented modules 112 may be regarded as being communicatively coupled. Where multiple of such hardware-implemented modules 112 exist contemporaneously, communications may be achieved through signal transmission (e.g., over appropriate circuits and buses) that connect the hardware-implemented modules. In embodiments in which multiple hardware-implemented modules 112 are configured or instantiated at different times, communications between such hardware-implemented modules may be achieved, for example, through the storage and retrieval of information in memory structures to which the multiple hardware-implemented modules 112 have access. For example, one hardware-implemented module 112 may perform an operation, and may store the output of that operation in a memory device to which it is communicatively coupled. A further hardware-implemented module 112 may then, at a later time, access the memory device to retrieve and process the stored output. Hardware-implemented modules 112 may also initiate communications with input or output devices.

As illustrated, the computing system 100 may be a general purpose computing device, although it is contemplated that the computing system 100 may include other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the general purpose computing device may include various hardware components, such as a processor 102, a main memory 104 (e.g., a system memory), and a system bus 101 that couples various system components of the general purpose computing device to the processor 102. The system bus 101 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing system 100 may further include a variety of computer-readable media 107 that includes removable/non-removable media and volatile/nonvolatile media, but excludes transitory propagated signals. Computer-readable media 107 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the general purpose computing device. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 104 includes computer storage media in the form of volatile/nonvolatile memory such as read only memory (ROM) and random access memory (RAM). A basic input/output system (BIOS), containing the basic routines that help to transfer information between elements within the general purpose computing device (e.g., during start-up) is typically stored in ROM. RAM typically contains data and/or program modules that are immediately accessible to and/or presently being operated on by processor 102. For example, in one embodiment, data storage 106 holds an operating system, application programs, and other program modules and program data.

Data storage 106 may also include other removable/non-removable, volatile/nonvolatile computer storage media. For example, data storage 106 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules and other data for the general purpose computing device 100.

A user may enter commands and information through a user interface 140 or other input devices 145 such as a tablet, electronic digitizer, a microphone, keyboard, and/or pointing device, commonly referred to as mouse, trackball or touch pad. Other input devices 145 may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices 145 are often connected to the processor 102 through a user interface 140 that is coupled to the system bus 101, but may be connected by other interface and bus structures, such as a parallel port, game port or a universal serial bus (USB). A monitor 160 or other type of display device is also connected to the system bus 101 via user interface 140, such as a video interface. The monitor 160 may also be integrated with a touch-screen panel or the like.

The general purpose computing device may operate in a networked or cloud-computing environment using logical connections of a network interface 103 to one or more remote devices, such as a remote computer. The remote computer may be a personal computer, a server, a router, a network PC, a peer device or other common network node, and typically includes many or all of the elements described above relative to the general purpose computing device. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the general purpose computing device may be connected to a public and/or private network through the network interface 103. In such embodiments, a modem or other means for establishing communications over the network is connected to the system bus 101 via the network interface 103 or other appropriate mechanism. A wireless networking component including an interface and antenna may be coupled through a suitable device such as an access point or peer computer to a network. In a networked environment, program modules depicted relative to the general purpose computing device, or portions thereof, may be stored in the remote memory storage device.

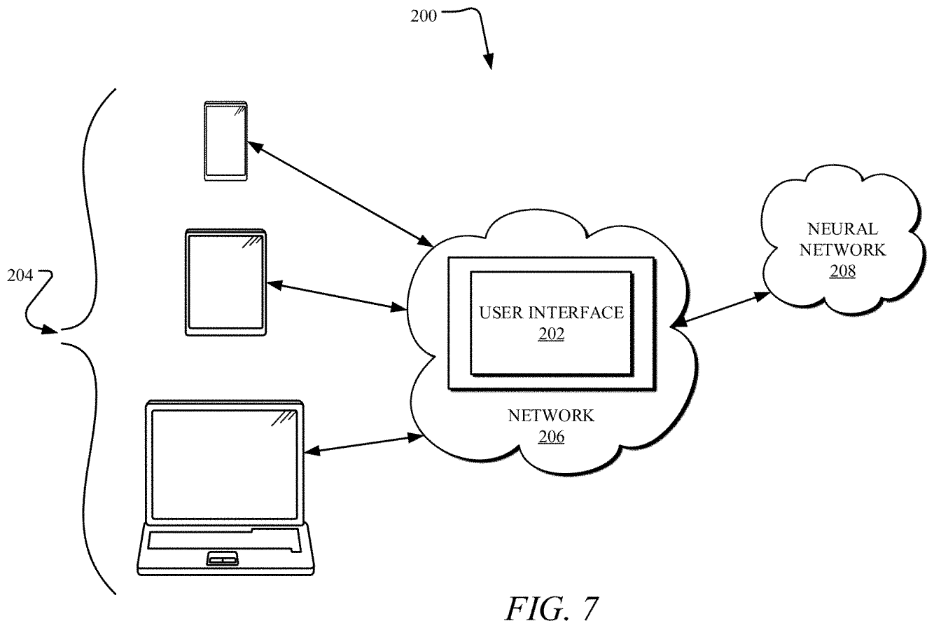

FIG. 7 is a network system 200 for illustrating a system for gray-box adversarial testing for control systems with machine learning components. The system may be generally comprised of one or more computing devices configured with aspects of the functional and computational systems described herein. In other words, the aforementioned computations for implementing the system can be translated to computing code and installed to one or more computing devices, thereby configuring such computing devices with functionality for gray-box adversarial testing for control systems with machine learning components. In some embodiments, the network environment of the system for gray-box adversarial testing for control systems with machine learning components may include a plurality of user devices 204. The user devices 204 may access a user interface 202 via a network 206 in communication with a neural network 208.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method of testing a neural network agent by simulating systems data, comprising:
executing, by a processor, instructions stored within a tangible storage medium in communication with the processor to perform operations, comprising:
accessing a non-linear control system associated with a neural network configured to execute at least one differentiable activation function;
expressing a property of the control system using signal temporal logic; and
generating using a local optimal control based search and a global optimizer a plurality of adversarial test cases for the control system.

2. The method of claim 1, wherein the neural network is a feed forward neural network.

3. The method of claim 1, wherein the neural network is a recurrent neural network.

4. A method of adversarial testing of a neural network agent by simulating systems data, comprising:
accessing, by a processor, a plant defining a mathematical model of a non-linear control system and a neural network associated with the plant, the neural network trained to represent forward dynamics of the plant by training the neural network using data collected from operation of the non-linear control system and the plant;
computing, by the processor, parameters associated with an adversarial, the parameters, when inputted to the neural network, falsifying a predefined requirement of the plant, by:
expressing a property of the plant via the neural network using temporal logic,
utilizing a local optimal control based search and a global optimizer.

5. The method of claim 4, further comprising given an initial trajectory and its corresponding initial conditions and input, providing, by the processor, a gradient-based falsification framework for finding a falsifying final trajectory.

6. The method of claim 4, further comprising associating adversarial robustness values to inputs and initial conditions for falsifying a given formula associated with the plant.

7. The method of claim 4, further comprising facilitating improvement to training of the neural network by leveraging adversarial inputs and their corresponding known outputs.

8. The method of claim 4, wherein the global optimizer includes uniform random sampling and simulated annealing optimization.

9. The method of claim 4, wherein the neural network predicts a response of the plant over a predetermined time period.
